(19) United States
(12) Patent Application Publication
(10) Pub. No.: US 2026/0070845 A1
(43) Pub. Date: Mar. 12, 2026

(54) LOW-DENSITY HIGH-STRENGTH CONCRETE AND RELATED METHODS USING FOAMED GLASS AGGREGATES

(71) Applicant: Aero Aggregates of North America, LLC, Eddystone, PA (US)

(72) Inventors: Archibald Filshill, Eddystone, PA (US); Theresa A. Loux, Eddystone, PA (US)

(73) Assignee: Aero Aggregates of North America, LLC, Eddystone, PA (US)

(21) Appl. No.: 19/320,079

(22) Filed: Sep. 5, 2025

Related U.S. Application Data
(60) Provisional application No. 63/691,494, filed on Sep. 6, 2024.

(51) Int. Cl. C04B 28/04; C04B 14/24; C04B 18/14; C04B 103/44; C04B 103/56; C04B 111/00; C04B 111/40

(52) U.S. Cl. CPC C04B 28/04; C04B 14/24; C04B 18/146; C04B 2103/44; C04B 2103/58; C04B 2111/00103; C04B 2111/40; C04B 2201/20; C04B 2201/50

(57) ABSTRACT

The invention provides a low-density, high-strength concrete composition, which is self-compacting and lightweight, with a low weight-fraction of aggregate to total dry raw materials, and a highly homogenous distribution of an absorptive lightweight aggregate such as glass microspheres and, optionally, polymer beads, as well as the methods for providing the composition or components. Lightweight concrete formed by the disclosed concrete composition have low density, high strength-to-weight ratios, and high R-value. The concrete has strength like that ordinarily found in structural lightweight concrete. The concrete, at the density ordinarily found in structural lightweight concrete, has a higher strength and, at the strength ordinarily found in structural lightweight concrete, a lower density.

### RELATED APPLICATION

This application claims the benefit of U.S. Provisional Ser. No. 63/691,494 , filed on Sep. 6, 2024. The entire contents of the provisional application are hereby incorporated by reference.

### TECHNICAL FIELD

The present invention relates to the field of concrete, more specifically to improved concrete compositions and methods for preparing improved concrete compositions and related concrete products.

### BACKGROUND OF THE INVENTION

Concrete is a composite material composed of a coarse granular material (known as aggregate or filler) embedded in a hard matrix of binder material (the cement or glue, e.g., Portland cement), which binds the aggregate and holds the aggregate together, at least partially filling the space around the aggregate. Concrete is mixed as a semi-liquid slurry, which then cures into a durable, hard structure. Concrete can be poured in place and molded or otherwise formed into a variety of structural shapes. The flowability, formability, and strength of concrete makes it a versatile material, which can be used in different types of structures in construction projects including, but not limited to, architectural structures, foundations, mortar, walls, pavement for highways and runways, parking structures, bridges, dams, pools, pipes, tanks, fences, poles, and even boats.

Concrete has been used for thousands of years, but its use as a construction material has certain limits. For example, if concrete is used in finished structures and products, certain characteristics of concrete must be considered including its weight, relatively poor tensile strength, ductility, the inability to readily cut, drill or nail, and poor insulating properties. Other limitations related to preset concrete include weight, limited flowability (and/or reduced strength caused by adding water to overcome the same), requirement to vibrate or otherwise compact the concrete to limit voids, segregation of aggregate, and the like. Further limitations related to the precursor materials or components include cost, weight, and segregation of aggregate and other materials.

Lightweight concretes have been developed to reduce the limiting effect of the weight of, among other things, finished concrete structures and products and uncured concrete. Such lightweight concretes (“LWC”) typically involve replacing some or all the aggregate in a mix with an aggregate, which is less dense than commonly used aggregate. Such aggregate may be known as lightweight aggregate (“LWA”). LWCs often have lower strength (such as tensile, compressive, elastic modulus, etc.) compared to non-LWA concrete, but LWCs can have higher strength-to-weight ratios due to the reduced density and weight of the concrete for a given structure or product.

Structural LWC is ordinarily considered to have a density between about 90-120 lb/cu. ft. and a compressive strength from 2500 psi to over 8000 psi. These values may be measured by ASTM C567 and ASTM C39, respectively.

The characteristics of set and cured concrete and of unset concrete can be measured. These characteristics include tensile strength, compressive strength, elastic modulus, modulus of rupture, plastic density, bulk density, oven-dried density, R-value, coefficient of thermal expansion, crack resistance, impact-resistance, fire resistance, slump, water/cement ratio, paste content by volume, weights, and weight-fractions.

The amount or characteristics of LWA used, or the amount of ordinary aggregate replaced by LWA, may be constrained by the need to meet certain minimum characteristics, including, but not limited to, tensile strength, compressive strength, elastic modulus, flexural strength, or modulus of rupture. Other constraints may include segregation of the LWA within the concrete.

In some cases, admixtures may be added to the concrete mix or to the precursor materials to improve one or more of the characteristics of the cured and/or uncured concrete. Admixtures may be liquid or solid, but are typically liquid unless the mix is to be kept in the dry state, such as for making bagged concrete mix.

It is an advantage for LWC to have a reduced density, higher strengths, higher strength-to-weight ratios, and increased R-value, as well as improved crack resistance, impact-resistance, and fire resistance. Reduction of the density and weight of the concrete offers a variety of advantages, including but not limited to, reduced structure weight and loading in dead loads in buildings and structures; easier and cheaper transportation and handling of the concrete products, lower transportation costs (equipment/fuel); improved thermal insulating properties, fire resistance, and acoustical properties.

### BRIEF SUMMARY OF THE INVENTION

The present invention provides self-compacting LWC having a low density, high strength-to-weight ratio, good segregation-resistance, and a high R-value. The present invention also provides non-self-compacting LWC having a low density, high strength-to-weight ratio, good segregation-resistance, and a high R-value. The present invention provides further LWC having a high replacement volume, a low weight-fraction of aggregate to total dry raw materials, and highly homogenous distribution of LWA.

LWC includes LWA composed of foam glass aggregates, a foaming agent, and optionally polymer beads.

Embodiments of LWC and LWC mixes include those in which other aggregates are present in addition to one or more types of LWA. Such ordinary aggregates may include, but are not limited to, sand and gravel. Embodiments also include LWC including LWA both with reinforcing materials, such as fiber or steel rod (re-bar) or wire mesh or other forms of reinforcing, or without reinforcement.

Embodiments of LWC and LWC mixes include cementitious materials, which may include one or more materials such as hydraulic cements, Portland cements, fly ash, silica fume (fumed silica), pozzolana cements, gypsum cements, aluminous cements, magnesia cements, silica cements, and slag cements. Cement may also be colored.

The present invention provides methods of preparing LWC mix having a high replacement volume, a low weight-fraction of aggregate to total dry raw materials, and highly homogenous mix properties.

The present invention provides methods of preparing LWC mix having a more moderate replacement volume and weight-fraction of aggregate to total dry raw materials, and highly homogenous mix properties.

The present invention provides methods of preparing LWC mix having a low replacement volume, high weight-fraction of aggregate to total dry raw materials, and highly homogenous mix properties.

LWC mixes includes LWA composed of foam glass aggregates and a foaming agent, as described above. A mix may be prepared with liquids for forming concrete therefrom, or as a dry mix, such as for a bagged concrete mix. A wet mix may be prepared, for example, in either a drum-type mixer, a pan-type mixer, or a ribbon mixer. A dry mix may be prepared, for example, in a pan-type mixer.

The present invention provides wet mix methods. These methods include ready mix methods, such as concrete precursor materials prepared and mixed on-site, either for use on-site or for transport, and such as concrete precursor materials forming the unmixed components of LWC mix, prepared for batching and mixed during transportation. Admixtures may be added during mixing, or during batching.

The present invention provides dry mix methods. These methods include dry concrete precursor materials prepared and mixed or blended on-site, with only dry admixtures if necessary, and bagged or otherwise prepared for sale.

The present invention provides manufacturing and mixing processes. Such processes include a concrete manufacturer acquiring concrete precursor materials including water (such as either by purchase or extraction) and any admixtures, preparing batches, weighing or otherwise measuring them individually (or together in such a way as to permit the components to be measured), and providing the unmixed components of LWC mix, such as by depositing the components into a concrete mixing truck. Such processes also include a concrete manufacturer acquiring concrete precursor materials including water (such as either by purchase or extraction) and any admixtures, preparing batches including weighing the components individually, holding them for delivery, and providing the components, such as by depositing the components into a stationary concrete mixer or other type of mixer.

In the case of a stationary concrete mixer, a concrete manufacturer may use the mixed concrete on-site, such as for a structure or a pre-caster. A pre-caster casts concrete products on-site or off-site using molds or forms, but those products are typically transported for use elsewhere. Examples of pre-cast products include, but are not limited to, concrete blocks, structural beams, and architectural panels.

The above embodiments may also be LWC compositions, which are not self-compacting.

It is to be understood that both the foregoing general description and the following detailed description are exemplary, but are not restrictive, of the invention.

### DETAILED DESCRIPTION OF THE INVENTION

The concrete composition disclosed includes: (a) LWA composed of (i) glass microspheres, (ii) a foaming agent, such as aerogels, calcium carbonates, silicon carbinde, foamed particles, foams incorporating air bubbles such as those formed by including air entrainment admixtures, and other additives based on mix or design, (iii) a combination of such foaming agent and such glass microspheres, and, optionally (iv) optionally polymer beads; (b) wet LWC mix comprising such LWA; (c) unmixed components of LWC mix comprising such LWA; (d) dry LWC mix comprising such LWA; (e) LWC formed of or comprising such LWA; (f) manufactured or pre-cast products comprising LWC formed of or comprising such LWA; (g) the process of preparing batches of components of LWC mix comprising such LWA; and (h) the process of mixing LWC mix comprising such LWA.

In any cementitious bound matrix, LWA disclosed above can replace 1-100% of the natural sands and aggregates. The disclosed LWA serves as an internal curing agent in a cementitious bound matrix by providing a reservoir of moisture within the concrete or mortar mixture. This internal curing process helps mitigate the effects of autogenous shrinkage and ensures better hydration of cementitious materials throughout the structure.

Specifically, the disclosed LWA acts as a Moisture Reservoir. The disclosed LWA has inherent porosity due to its structure. These pores/etchings can absorb and retain water. During the mixing process, water saturates these pores/etchings, effectively turning the LWA into a reservoir for moisture. When the cementitious material undergoes hydration, it consumes water from the mixture. LWA gradually releases moisture into the surrounding cementitious matrix. This moisture replenishment helps to maintain a favorable environment for hydration reactions to continue over time.

One of the significant benefits of internal curing with lightweight aggregate is the reduction of autogenous shrinkage. Autogenous shrinkage occurs when the cementitious materials lose moisture faster than they can absorb it from the surrounding environment. This leads to the development of internal stresses and potential cracking within the concrete or mortar. By providing a steady supply of moisture, LWA helps mitigate this shrinkage, resulting in reduced cracking and improved durability. Indeed, proper hydration of cementitious materials is essential for achieving optimal strength and durability in concrete or mortar structures. Internal curing facilitated by the LWA ensures that hydration continues uniformly throughout the matrix, promoting the development of stronger and more durable concrete or mortar.

The use of the disclosed LWA as an internal curing agent contributes to improved performance characteristics of the cementitious bound matrix, including reduced permeability, increased resistance to freeze-thaw cycles, and enhanced long-term durability. In summary, the disclosed LWA acts as an internal curing agent by providing a consistent source of moisture within the cementitious matrix, which helps mitigate shrinkage and ensures thorough hydration of the cementitious materials. This process ultimately leads to improved performance and durability of concrete or mortar structures.

The amount of LWA needed to achieve effective internal curing performance in concrete mixes depends on various factors, including the specific requirements of the project, the desired properties of the concrete, and the environmental conditions. However, there are some general guidelines and recommendations regarding the optimum ratio of lightweight aggregate to standard density aggregate for internal curing benefits.

One common approach is to replace a portion of the standard density aggregate with lightweight aggregate in the concrete mix. The volume replacement ratio typically ranges from 20% to 50% or more, depending on the desired level of internal curing and the characteristics of the lightweight aggregate used. The water-to-cement ratio is also a critical factor in concrete mix design and internal curing. Higher volumes of LWA may require adjustments to the water-to-cement ratio to maintain the desired workability and strength properties of the concrete.

The particle size distribution of LWA and its compatibility with the standard density aggregate are important considerations. A well-graded mix of aggregates helps optimize packing density and improves the overall performance of the concrete.

The curing conditions during and after placement of uncured concrete also influence the effectiveness of internal curing. Adequate curing methods, such as moisture retention and temperature control, should be employed to facilitate hydration and achieve the desired properties.

Trial mixes and performance testing may be conducted to determine the optimal ratio of lightweight aggregate to standard density aggregate for a specific application. This may involve laboratory testing and field trials to evaluate the mechanical properties, durability, and long-term performance of the concrete. In summary, while there is no universally applicable optimum ratio of LWA to standard density aggregate for internal curing benefits, engineers and concrete producers can use guidelines, experience, and testing to determine the most suitable mix design for their projects. Flexibility in adjusting mix proportions based on project requirements and performance criteria is key to achieving successful internal curing and desired concrete properties.

The present invention provides self-compacting LWC having a low density, high strength-to-weight ratio, high strength-to-density ratio, and good segregation-resistance. The present invention provides LWC having a high replacement volume, a low weight-fraction of aggregate to total dry raw materials, and highly homogenous distribution of LWA.

### Glass Microspheres

LWA of the invention are glass microspheres, which are less dense than water and are substantially resistant to volumetric change (or dimensional change) under pressure. The glass microspheres may be closed cell and may have a size distribution such that about 99% are smaller than about 150 micrometers. In other embodiments, LWA of the invention are porous glass spheres (i.e., glass spheres having a porous surface). In such embodiments, the porous glass spheres may have, or lack, a hollow vacuum center. Although ccommercial glass microspheres are typically smooth, the surface could be etched, such as by acid-washing or other methods.

LWA may be composed of a mixture of two or more types of glass microspheres, such that the two or more varieties compose all of the LWA in the LWC. This mixed LWA provides the advantage of enabling the concrete design to meet certain density and/or strength or strength-to-weight targets, which may be difficult with just one type of LWA.

### Aggregates

Embodiments of LWC and LWC mixes also include those in which other aggregates are present, in addition to one or more types of LWA. Examples of such ordinary aggregates include sand, gravel, pea gravel, pumice, perlite, vermiculite, scoria, and diatomite; concrete aggregate, expanded shale, expanded slate, expanded clay, expanded slag, pelletized aggregate, tuff, and macrolite; and masonry aggregate, expanded shale, clay, slate, expanded blast furnace slag, sintered fly ash, coal cinders, pumice, scoria, pelletized aggregate and combinations of the foregoing. Other ordinary aggregates that may be used include, but are not limited to, basalt, sand, gravel, river sand, river gravel, volcanic sand, volcanic gravel, synthetic sand, and synthetic gravel.

### Cementitious Materials

Embodiments of LWC and LWC mixes include cementitious materials. LWC and LWC mixes can include hydraulic cement, Portland cement including a Type I, Type I-P, Type II, Type I/II (meeting both Types I and II criteria) or Type III Portland cement, fly ash, glass pozzolan, and/or silica fume. These cementitious materials undergo a chemical reaction resulting in the formation of bonds with itself and other cementitious materials present, any aggregate, and any reinforcing materials.

Such exemplary cement types are defined in ASTM C150 and may be described generally as having the following particularly appropriate uses: Type I (general), Type I-P (blended with a pozzolan, including fly ash), Type IA (air-entraining Type I), Type II (general—with need for moderate sulfate resistance or moderate heat of hydration), Type IIA (air-entraining Type II), Type III (with need for high early strength), and Type IIIA (air-entraining Type III). Portland cements are powder compositions produced by grinding Portland cement clinker, a limited amount of calcium sulfate which controls the set time, and minor constituents (as allowed by various standards). The specific gravity of Portland cement is typically about 3.15.

Fly ash is a cementitious material, which is a byproduct of coal combustion. Pulverized coal is burned in the presence of flame temperatures of to 1,500 degrees Celsius. The gaseous inorganic matter cools to a liquid and then solid state, forming individual particles of fly ash.

Types of fly ash include Class C and Class F. Based upon ASTM C618, Class F fly ash contains at least 70% pozzolanic compounds (silica oxide, alumina oxide, and iron oxide), and Class C fly ash contains between 50% and 70% of these compounds. Such fly ash can reduce concrete permeability, with Class F tending to have a proportionately greater effect. Class F fly ash also protects against sulfate attack, alkali silica reaction, corrosion of reinforcement, and chemical attack. The specific gravity of fly ash may range from 2.2 to 2.8.

Fly ash, as a cementitious material reacts with water present in the mix. Fly ash is believed to improve workability of the cement mixture once mixed with water. In addition, fly ash reduces manufacturing costs because it is less expensive by weight than either cement or microspheres.

Silica fume is a cementitious material, which is a powdered form of microsilica. Silica fume reacts with calcium hydroxide in the cement paste present in the mix. It is believed silica fume improves strength and durability of the concrete product by increasing bonding strength of the cementitious materials in the concrete mix and reducing permeability by filling voids in among cement particles and the LWA (such as the glass microspheres).

### Water Content

With the invention, the amount of water in the wet concrete mix will depend in many instances on the desired water-to-cement (W/CM) ratio and amount of cement or cementitious materials in the concrete mix. In general, a lower W/CM ratio creates stronger concrete but, also, a lower slump value, reduced workability, and ability for the wet concrete mix to flow. More water is used in mixing concrete than is required, merely for workability. But thinning the wet concrete mix reduces its strength. Admixtures can be used to reduce the amount of water needed for workability, but, at the cost of increased manufacturing costs, from the expense of the admixtures. Ordinarily, a minimum W/CM ratio is 0.22 to permit sufficient hydration for the concrete to set properly. W/CM ratios can range upward therefrom to about 0.40, from about 0.57-0.62, about 0.68 or above, and at levels ranging between any of the values stated above. W/CM ratios around 0.22, or in the range of about 0.15-0.35, ordinarily are present in the case of the manufacture of concrete blocks, with the values for other concrete being higher. A higher W/CM ratio can be tolerated in those cases in which a concrete's design strength and strength-to-weight ratios are higher. A higher ratio is also tolerable if glass microspheres are reacting with cementitious materials, allowing for a portion of such glass microspheres to be used in the cementitious material calculations, thereby lowering the W/CM ratio.

A hydration stabilizer (or set retarding admixture) permits concrete production with better predictability by retarding the setting of the concrete to permit time for activities such as mixing, transport, placing, and finishing. By reducing the need to add water to delay setting during these activities (thereby decreasing the W/CM ratio), a water-reducer can improve strength and reduced permeability. An exemplary admixture meets ASTM C494 Type D, and can be, for example, EUCON brand STASIS or BASF brand Delvo.

A water-reducer (or set retardant) permits concrete production with better predictability by retarding the setting of the concrete to permit time for activities such as mixing, transport, placing and finishing. By reducing the need to add water to delay setting during these activities (thus increasing the W/CM ratio), a water-reducer can improve strength and reduce permeability. Exemplary water reducers include lignosulfonates, sodium naphthalene sulfonate formaldehyde condensates, sulfonated melamine-formaldehyde resins, sulfonated vinylcopolymers, urea resins, and salts of hydroxy- or polyhydroxy-carboxylic acids, a 90/10 w/w mixture of polymers of the sodium salt of naphthalene sulfonic acid partially condensed with formaldehyde and sodium gluconate and combinations thereof. An example of a water-reducer is EUCON brand NR.

### Reinforcing Materials

The present invention provides LWC including reinforcing materials, such as fiber or steel rod (re-bar) or wire mesh, and LWC mixes including reinforcing materials, such as fiber, as well as the processes of preparing and/or batching them. Reinforcing materials increase tensile strength and resist tensile stresses in portions of the concrete where cracking, as well as other structural failures, might otherwise occur. Inclusion of fiber in a concrete mix can reduce plastic shrinkage and thermal cracking and improve abrasion resistance, as well as flexural characteristics of concrete products. Fiber is believed to bond with the concrete.

Suitable fibers may include glass fibers, silicon carbide, PVA fibers, aramid fibers, polyester, carbon fibers, composite fibers, fiberglass, steel fibers and combinations thereof. The fibers, or combinations thereof, can be used in a mesh or web structure, intertwined, interwoven, and oriented in any desirable direction, or non-oriented and randomly-distributed in LWC or LWC mix. The fiber amount may be adjusted to provide desired properties to the concrete.

### Admixtures

The present invention provides LWC mix including admixtures to improve the characteristics of the mix and/or the set concrete. Such admixtures include an air entrainment admixture, an air detrainer admixture, a superplasticizer (or high range water reducer), a viscosity modifier (or rheology-modifier), a shrinkage reducer, an expansive agent, latex, superabsorbent polymers, a hydration stabilizer (or set retarding admixture) or any combination of any of the foregoing. The admixtures may also include colorants, dispersing agents, water-proofing agents, set-accelerators, a water-reducer (or set retardant), bonding agents, freezing point decreasing agents, anti-washout admixtures, adhesiveness-improving agents, air, or any combination of any of the foregoing.

Exemplary plasticizing agents include, but are not limited to, polyhydroxycarboxylic acids or salts thereof, polycarboxylates or salts thereof; lignosulfonates, polyethylene glycols, and combinations thereof.

Superplasticizers provide concrete production with better workability and a reduced amount of water, which assists in forming flowable and self-compacting concrete. Exemplary superplasticizing agents include alkaline or earth alkaline metal salts of lignin sulfonates; lignosulfonates, alkaline or earth alkaline metal salts of highly condensed naphthalene sulfonic acid/formaldehyde condensates; polynaphthalene sulfonates, alkaline or earth alkaline metal salts of one or more polycarboxylates; alkaline or earth alkaline metal salts of melamine/formaldehyde/sulfite condensates; sulfonic acid esters; carbohydrate esters; and combinations thereof.

An air entrainment admixture can be used to form small or microscopic air voids in the set concrete, which results from a favorable size and spacing of air bubbles in the concrete mix. Small or microscopic air voids protect concrete from freeze/thaw cycle damage, while, also, improving W/CM ratio, resistance to segregation of components, workability, resistance to de-icing salts, sulfates, and corrosive water. An exemplary air entrainment admixture meets ASTM C260. For example, Euclid Chemical AEA-92 can be used. Conversely, LWC is free or substantially free of an air entrainer.

An air detrainer admixture (or air detrainer admixture) acts to reduce the entrained air (or plastic air content). An air detrainer can mitigate the reduced strength caused by entrained air (i.e. the volume comprising air lacks the strength of cement or aggregate) and, also, reduces the need to overdesign the concrete or concrete product due to that decrease in strength. Air may be present in the mix from a number of sources including, air entrained as a result of other admixtures (such as polycarboxylate based high-range water reducers); air entrained with aggregate; and air mechanically mixed into the mix. Admixtures may also increase the effect caused by the other two sources. Without being bound by any theory, it is believed that LWA having a high relative surface area (because of small size) may also increase this effect, and result in an excessively high air content. Adding an air detrainer can reduce the air to a desirable level. Exemplary air detrainers include, but are not limited to, those based upon tributyl phosphate in a range of about 3.0 to about 7.0 weight percent, and acetic acid in a range of about 1.0 to about 5.0 weight percent, and is sold commercially as BASF brand PS 1390 (or MasterSure 1390). PS 1390 may be applied at about 0.2-3.0 oz. or about 0.2-1.0 oz., both per 100 lbs. of the cementitious materials. Other examples of air detrainers suitable for achieving reduction in air pores are products based on polyalkylene oxides, such as adducts of ethylene oxide or propylene oxide with alcohols or phenols; phosphates such as tributyl phosphate or triisobutyl phosphate, phthalates such as dibutyl phthalate, siloxanes such as polydimethylsiloxane, or phosphates of ethoxylated fatty alcohols, such as ethylene oxide stearyl phosphate. Suitable air detrainers are described in U.S. Patent Publication No. 2002/0132946 and U.S. Pat. No. 6,545,067, both of which are incorporated by reference.

A viscosity modifier (or rheology-modifying admixture) promotes formation of self-consolidating concrete by modifying the rheology of concrete, specifically by increasing the viscosity of the concrete, while still allowing the concrete to flow without segregation of aggregate or other materials in the mix. The increased viscosity permits small particles, including LWA such as the glass microspheres, to remain suspended in the mix, rather than segregating by sinking or floating. An exemplary admixture meets ASTM C494 Type S. Exemplary viscosity modifiers include, but are not limited to, those based upon or including 5-chloro-2-methyl-2H-isothiazol-3-one and is sold commercially as GRACE brand V-MAR 3. V-MAR 3 may be applied at about 4-16 oz. per 100 lbs. of the cementitious materials. Other exemplary viscosity modifiers include, but are not limited to, those based upon or containing quinolone, sodium hydroxide/[1,1′-Biphenyl]-2-ol, sodium salt (1:1) (or sodium sulfate) and is sold commercially as EUCON brand AWA. AWA may be applied at about 10-32 oz. per 100 lbs. of the cementitious materials. Other exemplary viscosity modifiers include, but are not limited to, those based upon or containing [1,1′-Biphenyl]-2-ol in a range of about 0 to about 0.2 weight percent or about 0.1 to about 1.0 weight percent, and ethylene glycol in a range of about 0 to about 1.0 weight percent or about 0.5 to about 1.5 weight percent, and sulfuric acid, and is sold commercially as BASF brand MasterMatrix VMA 362. VMA 362 may be applied at about 2-14 oz. per 100 lbs. of the cementitious materials.

A shrinkage reducer (or surface-tension reducing admixture or shrinkage reducing admixture) reduces shrinkage during the curing process caused by drying, which can create tensile stresses and induce cracking. The shrinkage reducer may operate by decreasing the surface tension of the water in the composition, thereby reducing the capillary tension created by water menisci in pores within the composition. Suitable shrinkage reducers include but are not limited to those based upon neopentyl glycol, alklyene glycol (such as 1,6-hexanediol, 1,5-pentanediol, 1,4-pentanediol, and 2-methyl-2,4-pentanediol), or a secondary and/or tertiary dihydroxy C3-C8 alkane, such as 2-methyl-2,4-pentadiol (hexylene glycol). Another exemplary shrinkage reducer is based upon a mixture of propylene oxide, 1,4-dioxane, and ethylene oxide and is sold commercially as BASF brand MasterLife SRA 20. Another exemplary shrinkage reducer is based upon propylene glycol and may be applied at about 1.0-1.5 lbs. per 100 lbs. of the cementitious materials or about 1.15 lbs. per 100 lbs. of the cementitious materials. Other shrinkage reducers can reduce shrinkage during the curing process by causing the concrete to expand during that process. This induces a compressive stress to offset tensile stresses caused by drying shrinkage. Such shrinkage reducers may also include an expansive agent.

An expansive agent could also be used with or without a shrinkage reducer. Differing materials may serve as expansive agents, but they have the common ability to cause an expansion of the concrete during curing. This may be accomplished by carrying out chemical reactions during the curing process. Non-limiting examples of expansive agents include calcium oxide (CaO) and calcium sulfo-aluminate ((CaO)₄(Al₂O₃)₃(SO₃). Use of CaO expansive agent produces a calcium hydroxide platelet crystal system based on calcium aluminate/calcium hydroxide; in particular, lime (CaO) is transformed into calcium hydroxide (Ca(OH)₂). Calcium sulfo-aluminate, with lime and anhydrite (CaSO₄), are converted into ettringite. Calcium oxide and calcium sulfo-aluminate are appropriate for use with reinforced concrete.

An admixture may combine a shrinkage reducer and an expansive agent. Another such admixture includes MgO, which has been lightly burnt (between 750-1200° C.) with a shrinkage reducing agent and a super absorbent polymer.

### Optional Polymers

Latex increases bonding within the concrete, reduces shrinkage and increases workability and compressive strength. Latex is a polymer, and Euclid Chemical FLEXCON and BASF brand STYROFAN are examples.

Superabsorbent polymers can be used to improve curing of the concrete including by providing internal water curing. Superabsorbent polymers can server as an internal reservoir of water, which is not part of the mix water (thus maintaining a low water/cement ratio). Internal water is used to promote curing (and, thus strength) and mitigate against shrinkage (which may induce cracking). Reducing the mix water can, also, reduce slump during the curing process. Superabsorbent polymers are a form of polymer capable of absorbing large volumes of water relative to their dry volume to swell, and then reversibly releasing that water to shrink. Polyacrylic acids are an example. They may be used with lower water/cement ratios (such as below 0.45 or below 0.42 or lower).

### Composition Characteristics

Fresh concrete has certain characteristics of interest, including slump, plastic air content, workability, and plastic density.

Slump is an important measure of the workability of a concrete mix. Slump is a measure of how easily a wet mix flows. Slump can be measured according to ASTM C143. Neither particularly high values, nor particularly low values, are preferable. Extremely low-slump applications include the manufacture of concrete blocks and other products. Low-slump applications include circumstances in which early form removal is necessary or desired, or when the concrete must otherwise be immediately self-supporting (or nearly so “0” slump) such as troweled-on applications. Normal-slump applications includes circumstances in which pumpability is critical, such as when concrete must be pumped.

Plastic air content is a measure of the percentage of the volume of the wet mix that constitutes air entrained in the mix. Plastic air content can be measured according to ASTM C231.

Plastic density is a measure of the density of the wet mix. Plastic density can be measured according to ASTM C138.

Cured concrete has many characteristics of interest, including bulk density, oven-dried density, thermal conductivity, and insulation value (or R-value), permeable porosity, modulus of rupture, compressive strength, elastic modulus, tensile strength, resistance to fire and combustibility, freeze/thaw resistance, drying shrinkage, chloride ion penetrability, abrasion resistance, the ring test, and CTE (coefficient of thermal expansion).

Compressive strength is a measure of the ability of the concrete to resist compressive loads tending to reduce its size until failure. Compressive strength can be measured according to ASTM C39. Higher compressive strength and strength-to-weight are an advantage with the invention because less weight reduces costs. This is the case, for example, in applications such as transportation and dead loads. Concrete compressive strength increases as the concrete ages, at least up to a point, and the hydration process (the chemical reaction within the cementitious materials) continues. Tests may be carried out at, for instance, 3, 4, 7, 14, and 28 days or even longer, as well as at other intervals.

Elastic modulus is a measure of concrete's tendency to be deformed elastically when a force is applied to it. Elastic modulus can be measured according to ASTM 649. Like compressive strength, elastic modulus increases as the concrete ages. Tests may be carried out at, for instance, 3, 7 and 28 days or even longer or at other intervals.

Tensile strength, or ultimate tensile strength, is a measure of the maximum stress that concrete can withstand while being stretched or pulled before failing or breaking. Tensile strength can be measured by ASTM C496. Like compressive strength, tensile strength increases as the concrete ages. Tests may be carried out at, for instance, 3, 7 and 28 days or even longer or at other intervals.

Modulus of rupture (or flexural strength) is a measure of concrete's ability to resist deformation under load. Modulus of rupture can be measured according to ASTM C78.

Oven-dried density is a measure of the density of a structural lightweight concrete. Oven-dried density can be measured according to ASTM C567.

R-value is a measure of the insulating effect of a material. Where thickness (T) is in inches, and thermal conductivity C_{T} is in (Btu-in.)/(hr-° F.-sq. ft), R-value is defined as T/C_{T}. C_{T} and R-value each have a non-linear relationship with the oven-dried density of concrete; the relationship is an inverse one for R-value. R-value may be influence by actual moisture content and the thermal conductivity of the material used in the concrete.

Bulk density may be measured according to ASTM 642. The permeable pores percentage may be measured according to ASTM 642. The resistance to fire may be measured according to ASTM E136. Combustibility can be measured according to ASTM E119.

Freeze/thaw resistance is a measure of concrete's resistance to cracking as a result of enduring freeze/thaw cycling. Freeze/thaw resistance can be measured according to ASTM C666.

Drying shrinkage is a measure of the percentage of volumetric reduction in size caused by the drop of the amount of water in the concrete as it dries. Drying shrinkage can be measured according to ASTM C157. It can be measured as ‘moist’ at 7 days, and as ‘dry’ at 28 days.

Chloride ion penetrability is a measure of the ability of the concrete to resist ions of chloride to penetrate. Chloride ion penetrability can be measured according to ASTM C1202. The measured values of the disclosed concrete ranged from about 133 to about 283 (in coulumbs).

Abrasion resistance is a measure of the ability of concrete's surface to resist damage from abrasion. Abrasion resistance can be measured according to ASTM C779. The measured values of the disclosed concrete ranged from about 0.032 to about 0.036 (in inches) and may be lower or higher.

The ring test is a measure of the ability of the concrete to resist nonstructural cracking. The ring test can be measured according to ASTM C1581. The measured values of the disclosed concrete ranged from about 10.1 to 16.2 (in days) and may be lower or higher.

CTE is the coefficient of thermal expansion and may be measured according to AASHTO T 336. The measured value of the disclosed concrete was 5.70×10⁶ (in in./in./° F.).

### Manufacture of LWC

According to the invention, a bagging facility prepares the concrete precursor materials for bagging and delivery and/or sale of bagged dry concrete (blended or mixed). These steps include acquiring bags and concrete precursor materials including cementitious materials, LWA, and optionally, aggregates, dry admixtures, and reinforcing materials. This may be done, for example, by purchase or extraction. A continuous process is used, in which the individual materials are measured by weight, blended, deposited into bags, which are sealed, and then sold and/or provided for sale.

LWC according to the invention has substantially greater insulating properties (higher R-value, lower thermal conductivity) than ordinary concrete, based upon the relationship between density and conductivity. However, LWC according to the invention has a much greater strength-to-weight (and-density) ratio, and thus can insulate better for a given mass and weight.

LWA (specifically in the case of the glass microspheres) is much less dense even than water, is the lowest-density component, and has the natural tendency to float to the top of a mix. This has several undesirable consequences. A primary one is that it can cause uneven properties of the concrete product or structure, resulting in visual deficiencies (i.e. visible aggregate maldistribution). Uneven properties might mean a portion of the product or structure having an excessively high concentration of LWA, thus displacing cementitious materials, might be weaker than designed. However, LWC and LWC mixes according to the invention have highly homogenous mix properties. That is, mix design largely prevents LWA from segregating within the mix.

The present invention provides a dry LWC mix having a low weight-fraction of aggregate to total dry raw materials and highly homogenous mix properties. This LWC mix forms LWC having a low-density, low thermal conductivity, high strength-replacement-volume factor, a high strength-to-weight ratio, and a high strength-to-density ratio. The LWC mix includes embodiments that use an LWA, which LWA includes glass microspheres and optionally polymer beads, as described above.

The present invention provides a self-compacting wet LWC mix comprising such a LWA and having such properties.

The present invention provides a process of preparing batches of components of a LWC mix (wet or dry) comprising such a LWA.

The present invention provides unmixed components of a LWC mix comprising such a LWA.

The present invention provides a process of mixing a LWC mix comprising such a LWA.

The present invention provides a process of providing unmixed components of a LWC mix comprising such a LWA for mixing.

The present invention provides a process of preparing dry LWC mix comprising such a LWA in a continuous process for bagging.

The present invention provides LWC formed of or comprising such a LWA having a low-density, low thermal conductivity, high strength-replacement-volume factor, a high strength-to-weight ratio, and a high strength-to-density ratio.

The present invention provides manufactured or pre-cast products comprising a LWC formed of or comprising such a LWA having such characteristics.

It is to be understood that the invention is not limited in this application to the details of construction and to the arrangements of the components set forth in the description or claims and/or illustrated in the drawings, if any. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

What is claimed is:

1. A lightweight concrete composition comprising:
one or more cementitious materials;
an aggregate mix composed of individual particles that are substantially volumetrically stable and non-absorbent, the aggregate mix comprising hollow glass microspheres;
a foaming agent; and, optionally,
an air detrainer;
a shrinkage reducer;
a viscosity modifier; and
combinations thereof
wherein the lightweight concrete composition has a weight of about 60 pounds per cubic foot and compressive strength after 28 days as measured by ASTM C39 of at least about 1750 psi.

2. The lightweight concrete composition of claim 1, wherein the foaming agent comprises an air entrainment admixture.

3. The lightweight concrete composition of claim 1, further comprising reinforcing fibers selected from the group consisting of glass fibers, carbon fibers, aramid fibers, steel fibers, and combinations thereof.
The lightweight concrete composition of claim 1, wherein the cementitious materials comprise Portland cement and silica fume.

5. The lightweight concrete composition of claim 1, wherein the shrinkage reducer comprises a glycol-based compound.

6. The lightweight concrete composition of claim 1, wherein the viscosity modifier is present in an amount of 2-16 ounces per 100 pounds of cementitious material.

7. The lightweight concrete composition of claim 1, wherein the hollow glass microspheres are closed-cell microspheres having a particle size less than 150 micrometers.

8. A method of preparing a lightweight concrete mix, comprising:
providing one or more cementitious materials;
providing an aggregate mix comprising hollow glass microspheres that are substantially volumetrically stable and non-absorbent;
combining the cementitious materials, the aggregate mix, and a foaming agent with water to form a concrete slurry; and
mixing the slurry under conditions sufficient to produce a substantially homogeneous distribution of the hollow glass microspheres,
wherein the resulting lightweight concrete has a density of about 60 to 120 pounds per cubic foot and a compressive strength after 28 days as measured by ASTM C39 of at least about 1750 psi.

9. The method of claim 8, further comprising adding a viscosity modifier to increase suspension stability of the hollow glass microspheres.

10. The method of claim 8, wherein the slurry is mixed in a drum-type mixer, a pan-type mixer, or a ribbon mixer.

11. The method of claim 8, wherein the hollow glass microspheres replace at least 20% by volume of standard density aggregate.

12. The method of claim 8, further comprising incorporating reinforcing fibers into the slurry prior to curing.

13. The method of claim 8, wherein the water-to-cement ratio is maintained between about 0.22 and 0.40.

14. The method of claim 8, further comprising curing the lightweight concrete under controlled moisture conditions to reduce autogenous shrinkage.

15. A precast concrete product comprising:
a hardened lightweight concrete body formed from a mix including cementitious materials, hollow glass microspheres, and a foaming agent;
wherein the lightweight concrete body has a density of less than about 100 pounds per cubic foot, an R-value greater than that of normal weight concrete of equivalent thickness, and a compressive strength after 28 days as measured by ASTM C39 of at least about 2500 psi.

16. The precast concrete product of claim 15, wherein the product is a structural beam, concrete block, or architectural panel.

17. The precast concrete product of claim 15, further comprising a reinforcing mesh embedded within the hardened lightweight concrete body.

18. The precast concrete product of claim 15, wherein the hollow glass microspheres are present in an amount of 10-50% by volume of the aggregate fraction.

19. The precast concrete product of claim 15, wherein the product exhibits a modulus of rupture of at least about 400 psi.

20. The precast concrete product of claim 15, wherein the hardened lightweight concrete body has a thermal conductivity at least 20% lower than that of conventional normal weight concrete.
